(19) United States
(12) Patent Application Publication
(10) Pub. No.: US 2005/0074062 A1
(43) Pub. Date: Apr. 7, 2005

(54) Fast DCT method and apparatus for digital video compression

(76) Inventors: Chih-Ta Star Sung, Glonn (DE); Chun Hung Lien, Danshuei Township (TW)

Correspondence Address: Chih-Ta Star Sung;RM. 105, BULD. 53, NO. 195, SEC. 4, CHUNG HSING RD., CHUTUNG TOWN, HSINCHU HSIEN, 310, TW

(21) Appl. No.: 10/678,916

(22) Filed: Oct. 6, 2003

(51) Int. Cl. H04N 7/12

(52) U.S. Cl. 375/240.2; 375/240.24

(57) ABSTRACT

The present invention provides method and apparatus of a fast DCT implementation. DCT calculation is combined with quantization scales by a procedure of pre-processing. During DCT coefficient calculation, only non-zero coefficients are calculated. If pixel variance range is smaller than a first predetermined threshold, a predetermined lookup table is compared to decide the DCT coefficients. When a pixel variance range of a block pixels is within the second threshold, coupled with the quantization scales, the pre-processing determines the amount of non-zero DCT coefficients need to be calculated. Only a limited amount of LSB bits within a block is applied in the calculation of DCT coefficients. A previously saved pixel with equal or closest pixel value is used to replace the operation of current pixel's multiplication.

### BACKGROUND OF THE INVENTION

1. Field of Invention

The present invention relates to digital image/video compression, and, more specifically to an efficient implementation method and apparatus of a Discrete Cosine Transform for compressing digital image/videodata.

2. Description of Related Art

Digital video has been adopted in an increasing number of applications, which include digital still camera (DSC), video telephony, videoconferencing, surveillance system, Video CD (VCD), DVD, and digital TV. In the past two decades, ISO and ITU have separately or jointly developed and defined some digital video compression standards including JPEG, MPEG, and H.26x. The success of development of the video compression standards fuels the wide applications. The advantage of image and video compression techniques significantly saves the storage space and transmission time without sacrificing much of the image quality.

Most ISO and ITU motion video compression standards adopt Y, Cb and Cr as the pixel elements, which are derived from the original R (Red), G (Green), and B (Blue) color components. The Y stands for the degree of “Luminance”, while the Cb and Cr represent the color difference that have been separated from the “Luminance”. In both still and motion picture compression algorithms, the 8×8 pixels “Block” based Y, Cb and Cr components go through the similar compression procedure individually.

A video picture normally has relatively complex variations in signal amplitude as a function of distance across the screen. It is possible to express this complex variation as a sum of simple oscillatory cosine waveforms that has the general behavior. At the heart of both JPEG and MPEG image and video compression algorithms resides the Discrete Cosine Transform, the DCT. As shown in FIG. 1, in JPEG and MPEG image and video compression standards, each component array in the input image frame 11 is firstly partitioned into N×M blocks 12. A block is comprised of a certain amount of pixels 13. The most commonly used block size is 8×8 pixels. The DCT transforms the time domain 8×8 pixels data into 8×8 frequency domain DCT coefficients. Which means the DCT captures the spatial redundancy and packs the signal energy into a few DCT coefficients. The coefficient in the [0,0] position within a DCT array is referred to as the “DC Coefficient” which dominates most information, the remaining 63 coefficients are classified as the “AC Coefficients”. The farer away from the DC corner, the less important the AC can dominate the information. Therefore the quantization step 22, the only step in JPEG and MPEG, which causes data loss, is applied to “filter out” the less important AC coefficient with sacrifice of more or less the image quality. The farer away from the DC corner, the larger quantization step can be applied without much sacrifice of image quality. FIG. 2b illustrates the DCT coefficient scanning order 23 it starts from the DC and ends in the right bottom coefficient. A key feature of the quantized DCT coefficient is that many of them are filtered out to be “0s” making them suitable for efficient coding. FIG. 2c demonstrates an example of an 8×8 block pixel DCT transform, the time domain raw pixel data 24 are transformed to be DCT coefficients 25, after quantization with scales ranging from 16 and higher, most AC coefficients are filtered out except for only one DC and one AC coefficient are non-zero 26.

The forward DCT equation is shown as:

$$F ( i , j ) = \frac{1}{\sqrt{2 N}} C ( i ) C ( j ) {\sum }_{x = 0}^{N - 1} {\sum }_{y = 0}^{N - 1} f ( x , y ) cos \frac{( 2 x + 1 ) i π}{2 N} cos \frac{( 2 y + 1 ) j π}{2 N}$$

The calculation of a single 8×8 DCT by using the standard definition of a DCT transform requires more than 9200 multiplications and more than 4000 additions. This is high cost in computing power. Many alternatives of significant improvement of the DCT implementation have been proposed and realized. When compressing an image signal, it is desirable to perform the DCT transformation quickly as compressing an image signal requires many DCTs to be performed. For example, to perform a JPEG compression of a 1024 by 1024 pixel color image requires 49,152 8×8 blocks of DCT. If 30 images are compressed or decompressed every second, as is suggested to provide full motion video, then a DCT must be performed every 678 ns this requires quite fast transform operations.

Since the DCT is a method of decomposing a block of pixel data into a weighted sum of spatial frequencies, FIG. 3 illustrates the spatial frequency patterns that are used for an 8×8 DCT. Each of these spatial frequency patterns has a corresponding “Coefficient”, the amplitude needed to represent the contribution of that spatial frequency pattern in the block of data being analyzed. From other words, each spatial frequency pattern is multiplied by its coefficient and the resulting 64 8×8 amplitude arrays are summed, each pixel separately, to reconstruct the 8×8 block of pixels. As shown in FIG. 3, the DC 31 needs only addition operations, the farer away from the DC corner 32, 34, 33, the more addition and multiplication operations will be needed to execute the AC coefficient transform. The right bottom is the 63^{rd} AC coefficient 35, which requires most addition and multiplication operations.

The encoding of video signals requires processing of a very high number of computing, e.g., millions per second. A prior art implementation of a fast DCT is disclosed, for example, in the article: “FAST ALGORITHMS FOR THE DISCRETE COSINE TRANSFORM”, by E. Feig and S. Winograd, IEEE Transactions on Signal Processing, Vol. 40, No. 9, September 1992. A system implementation for DCT calculation is disclosed in U.S. Pat. No. 5,197,021, titled “SYSTEM AND CIRCUIT FOR THE CALCULATION OF THE BIDIMENSIONAL DISCRETE TRANSFORM”. W. Pennebaker and J. Mitchell disclose another solution, in the article: “STILL IMAGE DATA COMPRESSION STANDARD,” Van Nostrand Reinhold, New York, 1993. However, when implementation of such approaches is sought on systems in which the critical calculation depends on various factors, a substantial loss in algorithm efficiency is often incurred. The common points of above disclosed DCT implementations are that the cosine functions and the square root function are separated from the input picture to form the so named “Base Function” coupled with the “Butterfly like” transpose memory and calculations as illustrated in FIG. 4.

### SUMMARY OF THE INVENTION

The present invention is related to a method and apparatus of a fast, two dimensional, discrete cosine transform (2-D DCT) calculation. The present invention significantly reduces the computing times compared to its counterparts specifically in the applications of the image compression.

The present invention combines the quantization step to determine the DCT coefficient calculations. The said “Pre-processing” means applies to diverse alternatives of the implementation of DCT.
According to one embodiment of present invention, the pre-processing block calculates the block pixel variance and determines how many coefficients should be calculated depends on the result of pre-processing block.
According to another embodiment of the present invention, the DCT calculation includes procedures and steps of quickly evaluating the pattern of at least one block. The result of evaluation determines how many DCT AC coefficients need to be calculated, and how many coefficients should be quantizatized to achieve the optimized image quality and the DCT calculation time.
According an embodiment of the present invention, if the pixel value variation within a block is less than a predetermined threshold value, the DCT coefficients are obtained by a lookup mapping means.
According to another embodiment of the present invention, a “pre-processing” procedure is applied to determine how many non-zero coefficients will be left after quantization and to calculate the non-zero DCT coefficients accordingly.
According another aspect of the present invention, there is provided a method of quick evaluation of the block pixels depending on the correlation between pixels, such as adjacent pixel difference, or a sum of difference between pixel and mean of block pixel. Adjacent pixel difference means the difference of two nearby pixel values, position of these pixels may be left and right sides, upper and lower sides and diagonal direction. The distance of each evaluated two pixels may be adjacent to more than one pixels.
According to another embodiment of the present invention, since high chance of having the same value of MSB bits, when calculating the pixel value range, average or sum of block pixels, only a few LSB, least Significant Bits are calculated. The MSB bits become the “base” and can be shifted up and are added to make up the final sum.
In accordance with another embodiment of the present invention, there is provided a method of skipping calculation of AC coefficients in DCT. Skipping how many calculations of AC coefficients depends on the pixel correlation within a block. Large variation of a block results in more non-zero coefficients, which means the pixel variation range determines how many AC coefficients should be calculated.
In accordance with another embodiment of the present invention, there is provided a method of rapidly determining the threshold value by adopting sub-sampled pixels.
In accordance with another embodiment of the present invention, a coming pixel is firstly compared to previously saved pixels to determine which results of the multiplication can be used as the result of present pixel's multiplication.
In accordance with another embodiment of the present invention, if no pixel with equal value is identified, the results of the multiplication of the pixel with closest value is selected and additional additions or subtractions are calculated to make up the pixel difference of the present and the closest pixel.
The method is implemented in a device such as an image or video encoding and a module of a digital image or video encoder that concurrently implements any of the above methods of the present invention in any combination thereof.

It is to be understood that both the foregoing general description and the following detailed description are by examples, and are intended to provide further explanation of the invention as claimed.

### BRIEF DESCRIPTION OF THE DRAWINGS

FIG. 1 shows the partitioning of a picture into blocks of pixels.

FIG. 2a depicts the basic image compression procedure comprising DCT plus quantization step that is most commonly adopted image and motion video applications.

FIG. 2b depicts the 8×8 DCT coefficients and the order of the coefficient zigzag scanning.

FIG. 2c depicts the 8×8 raw pixels, the corresponding DCT coefficients and the DCT coefficients. It is obvious that after quantization, only very limited amount of non-zero DCT coefficients are left.

FIG. 3 is a 2-dimentional “Base Function” of the 8×8 DCT. Each block is an 8×8 array of samples. Zero amplitude is neutral gray, negative amplitudes have darker intensities and positive amplitudes have lighter intensities.

FIG. 4 illustrates a prior art of a fast DCT implementation.

FIG. 5 depicts the flow chart of the method of the present invention of the fast DCT calculation.

FIG. 6 illustrates the concept of the invention of the DCT calculation with quantization with a means of pre-processing.

FIG. 7 depicts the block diagram of an apparatus of the present invention of a fast DCT calculation.

FIG. 8a depicts the complete 8×8. DCT coefficients before quantization.

FIG. 8b depicts the 8×8 DCT coefficients with some non-zero coefficients left after quantization.

FIG. 8c depicts the 8×8 DCT coefficients with very few non-zero coefficients left after quantization

FIG. 9 depicts a sub-sampling means with 2:1 sampling ratio, which is adopted in this invention for quicker pixel pre-processing and helps in quickly determining the DCT calculation.

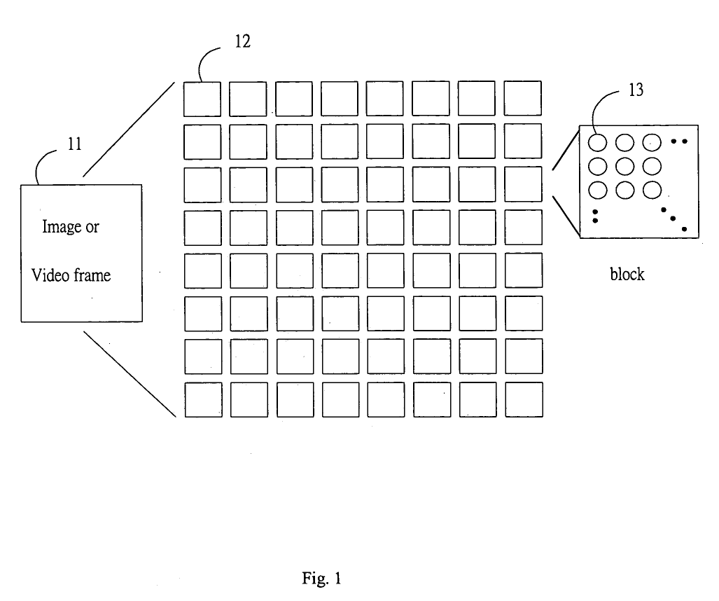

### DESCRIPTION OF THE PREFERRED EMBODIMENTS

The present invention relates specifically to the image compression. The method and apparatus quickly calculates the DCT, which results in a significant saving of the computing times.

The Discrete Cosine Transform, DCT plays an important role in image, video and audio compression applications. Both JPEG, a popular still image compression standard derived from ITU and MPEG, the ISO motion video compression standard have adopted DCT as the key function of transforming time domain pixels into frequency domain coefficients. The baseline JPEG still image compression standard has in principle five steps to achieve image compression which includes DCT, quaztization, Zigzag scanning, Run-Length packing and the Variable Length Coding, VLC. After DCT calculation, some AC coefficients are filtered out through quantization. The quantized DCT coefficients have high amount of “0s” in the more AC corner. The quantization in higher frequency AC coefficient do not cause much data loss since the higher frequency AC coefficients don't dominate too much information. There are in principle three types of picture encoding in the MPEG video compression standard including I-frame, the “Intra-coded” picture, P-frame, the “Predictive” picture and B-frame, the “Bi-directional” interpolated picture. The I-type frame image compression has same compression steps like JPEG. In P-type or B-type frame, after identifying the best match block which is done by the “motion estimation” subsystem, the block pixel difference between a block and the best match block in previous or future frame shall go through similar image compression steps like I-frame and JPEG compression.

DCT dominates more than 50% of computing power in most JPEG image compression and decompression. In most implementations, DCT is next to the “motion estimation” consumes the 2^{nd} highest times of computing in most motion video compression standards like MPEG and H.26x. After the DCT transform, the more close to the left top corner, the DCT coefficients dominate more information. From the other hand, the closer to the right bottom, the higher frequency and the less information the AC coefficients dominate. Therefore, the AC coefficients farer away from the DC and left top corner can be filtered out to be “0s” by larger quantization scales without sacrificing much image quality.

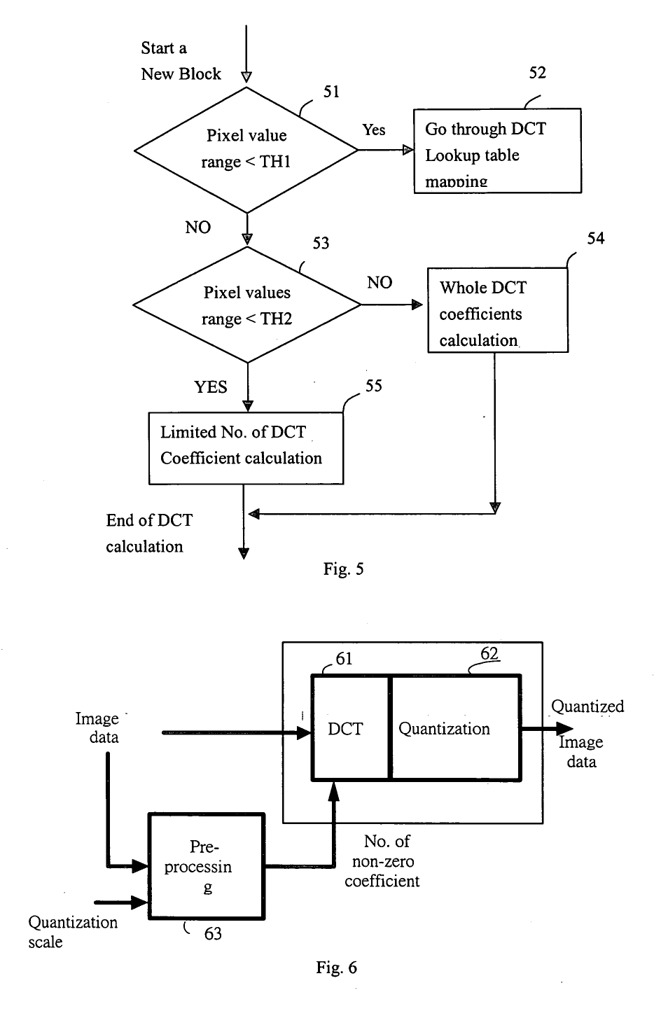

The present invention combines the steps of DCT and quantization together and put them into consideration when calculating the DCT coefficients. As shown in FIG. 5, if the pixel range within a block is smaller than an predetermined threshold 51, said TH1, which is determined by the quantization with a preset quantization scale, then all AC coefficients might be filtered out to be 0s and only the DC coefficient is left. If there is only DC left, then an easy means of calculation is to sum up all pixel data. Another possibility is that If the pixel range is smaller than TH1 but quantization scale is not large enough, then a limited AC, said 2-4 AC coefficients are non-zeros will go through the DCT mapping by comparing the pixel range, the pattern tone change and the quantization scale, the wanted limited amount of AC coefficients are easily identified by a means of said “mapping” 52. When the pixel range within a block is larger than TH1 and less than TH2, for efficiency of the DCT calculation, the DC and only a limited amount of AC coefficients, for example 2-4 AC coefficients are done by mapping means, the rest of higher frequency AC coefficients are calculated by firstly identifying how many non-zero AC coefficient need to be calculated 55. When the pixel variance range is beyond a threshold, said TH2, the whole DCT coefficients are calculated 54.

In present invention, the pre-processing step 63 is critical to the success of accurately deciding the amount of limited AC coefficient need to be calculated instead of all DCT coefficients. This results in a significant saving of computing times. The pre-processing 63 includes the procedure of quantization. It checks the pixel range of each block and looks into the quantization requirement to decide whether only DC coefficient left after quantization, or a very limited AC coefficient can be obtained by the means of lookup table mapping. The pre-processing step also identifies the final number of DCT non-zero coefficients need to be calculated by sending out a “Threshold Value” representing the amount of DCT coefficients need to be calculated to DCT 61 and quantization 62. In both JPEG and MPEG standards, the quantization scale decides the image quality. Which means, the larger the quantization step, the more data will be discarded which causes distortion. From the other hand, the selected image quality decides the quantization scale. Take the digital still camera, DSC as an example, most DSC let users choose “High, Mid and Low” quality of image. Receiving the image quality selection signal, the JPEG (or MPEG) encoder determines a table of the quantization scale for each of the 64 DCT coefficients. Comparing the block pixel variance range to the quantization scale of each DCT coefficient, the amount of non-zero DCT coefficients can be obtained. Which means, the block with more uniform pixel value, the less variance range and after DCT, the AC coefficients' values will be lower and will be less non-zero DCT coefficients left after quantization.

In present invention, since the correlation between adjacent pixels within the same block is very high, when calculating the pixel value range, average or sum of block pixels, only a few LSB, the Least Significant Bits need to be calculated. The MSB bits with same values become the “base” and can be shifted up and added to make up the total sum or to form the average of block pixels. Since only few LSB bits are different, summing the LSB bits plus the shifted MSB value can do the summation of block pixels. If the block pixel is beyond the predetermined threshold value 54, said TH2, then, a DC coefficient and the first 2-4 AC coefficients are calculated by mapping means with a lookup table storing the result of pixel variance and the corresponding DCT coefficients and the rest of the DCT coefficients are calculated by other efficient alternative of DCT calculation. The present invention can adopt any alternatives of the DCT calculations and use the selected means to calculate limited necessary DCT coefficients. Like the kid's so called “Piggyback” game, instead of all coefficients, the present invention calculates a limited amount of the non-zero coefficients which results in significant saving of the DCT coefficient calculation of any selected DCT calculation alternative.

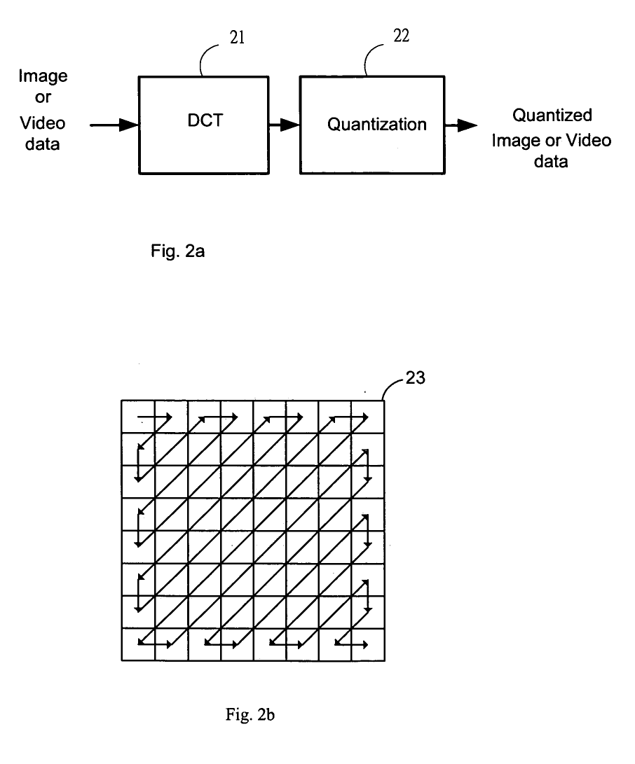

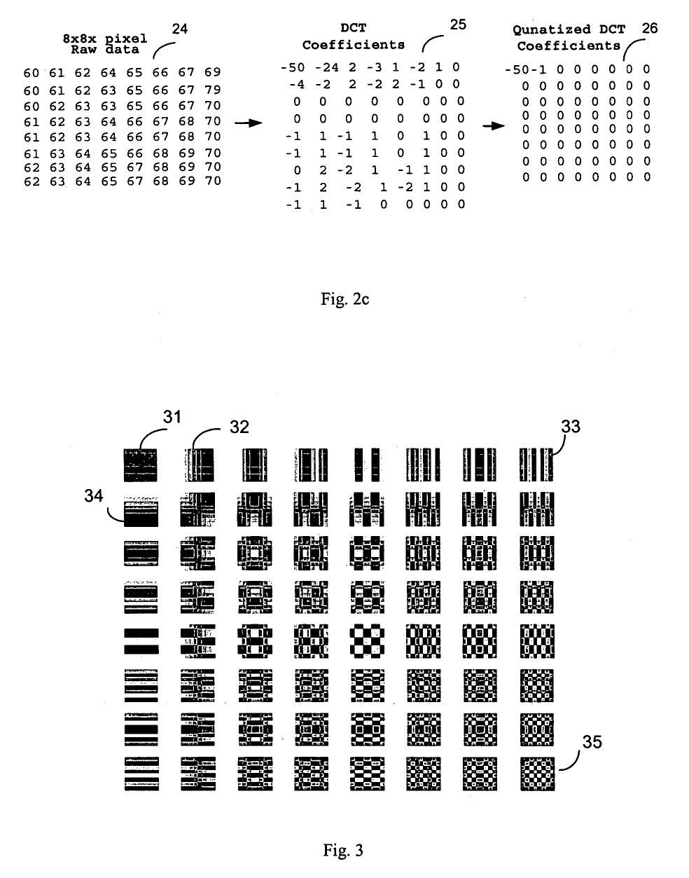

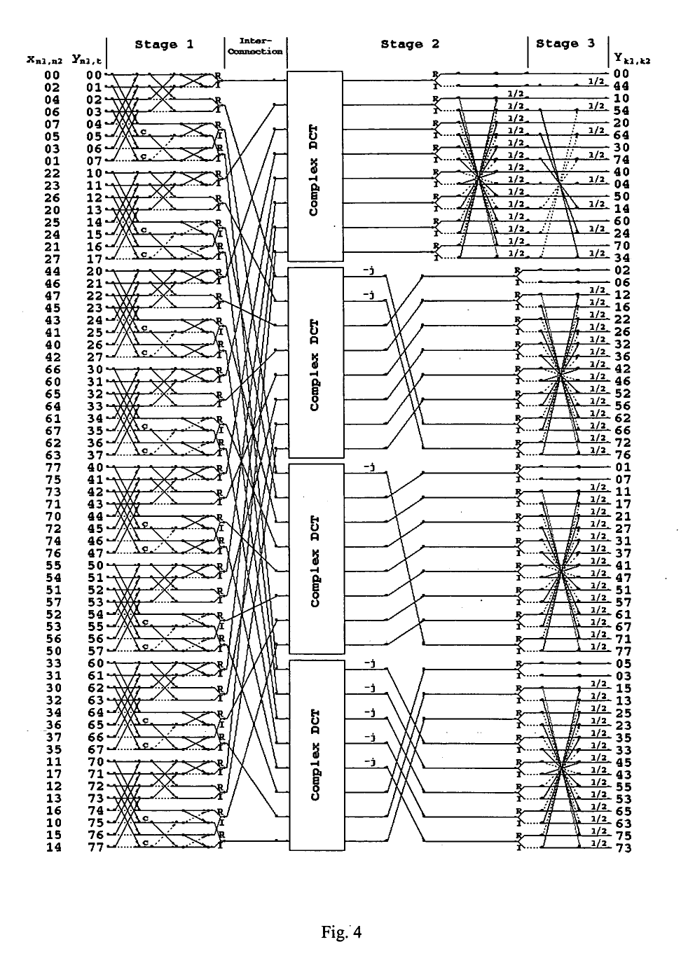

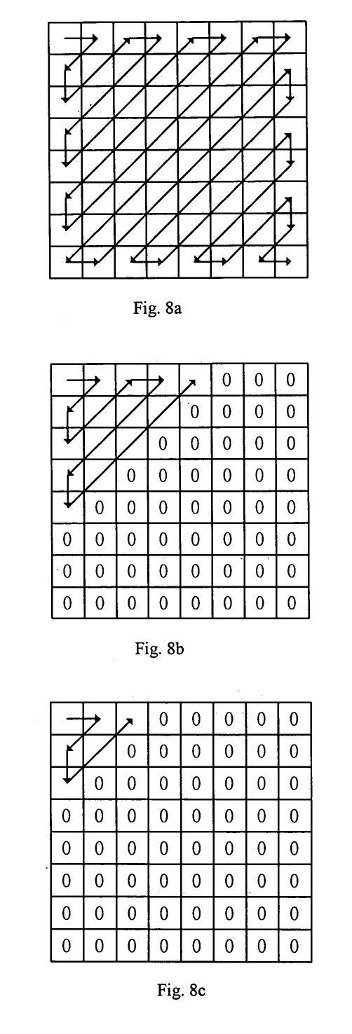

The present invention combines the DCT and quantization to determine how many DCT coefficients can be calculated by the means of a lookup table mapping and how many non-zero coefficients need to be calculated. For example, a block of 8×8 pixels as shown in FIG. 2c with pixel value variance less than 10, if the quantization scale is from 12, then, after quantization, there will be only the DC and one non-zero DCT coefficients left. Looking backward, one can use the block pixel variance and quantization scale to predict by the pre-processing 63. If the block pixel variance is greater than 15 and the quantization scale is 8, then, 1 DC and 5 non-zero AC coefficients will be left. In this pattern, the present invention will apply the lookup table mapping means to calculate the first 2 AC coefficients, and the rest of 3 AC coefficients will be calculated by a fast DCT calculation means. Nevertheless, only non-zero coefficients will be calculated. FIG. 8a illustrates the DCT coefficient scanning order. In JPEG and MPEG standard, there is an “End of Block” (EOB) code, which stands for no more non-zero coefficient. EOB is the most frequent happen pattern and is assigned a shortest code said “01” or “10” to represent it. FIG. 8b depicts the scanning procedure ending in the last non-zero coefficient. FIG. 8c depicts the scanning procedure of a block DCT coefficient that has smaller pixel variance range or larger quantization scale resulting in a smaller amount of non-zero DCT coefficients.

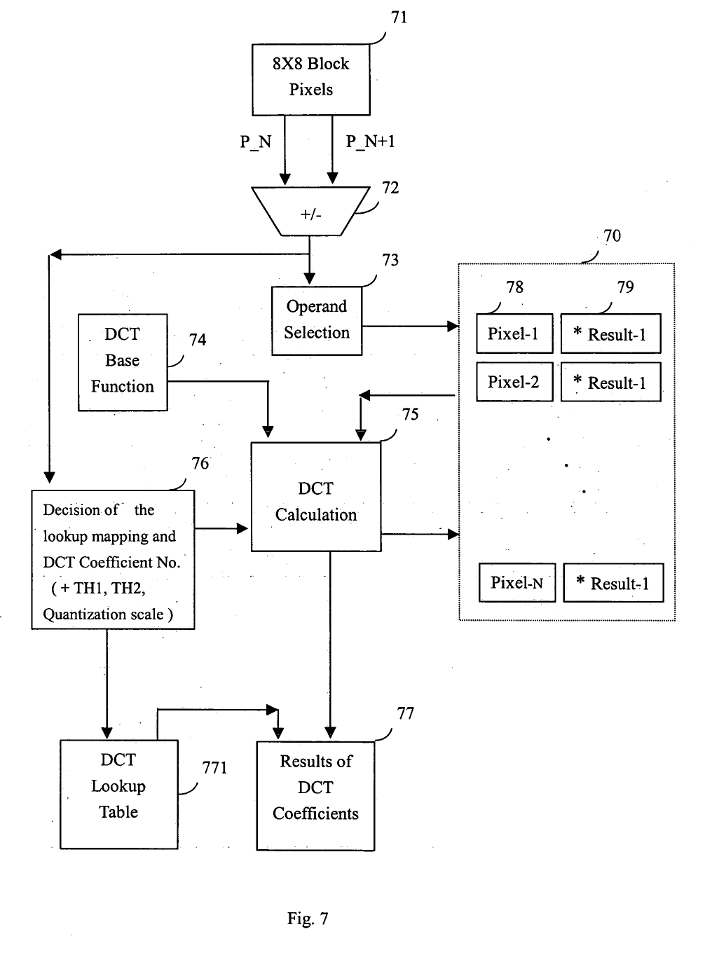

FIG. 7 shows the block diagram of the implementation of the present invention. A block pixels are stored in a temporary buffer 71 before the pixel is sent to compare to it adjacent pixel to decide whether one of the previous saved pixels is equal to the present pixel. If “YES”, then, the previously saved results from multiplication can be copied to represent the result of the multiplication. This saves operation time. The coming pixel and the pixel difference 72 are calculated to determine the pixel value variance. The pixel difference together with the quantization scale decides the number of the DCT coefficient that are non-zero which decision making 76 is done by comparing the pixel variance, quantization scale and the predetermined thresholds, TH1 and Th2 which are embedded inside the decision making block 76. For instance, If the pixel variance is within said TH1, and the quantization scale is greater than said 16 for all DCT coefficients, then there will be only 2 non-zero coefficients are left after quntization and the calculation of the DCT can be easily done by the lookup table mapping 771. If the pixel variance is larger than a threshold said TH1 or the quantization scale is less than said 8, there will be 4-6 non-zero AC coefficients left after quantization and the said a limited none-zero coefficients of DCT Calculations 75 is required. During the DCT calculation, some pixels might have equal pixels in the storage device 70 which saved previous pixels and the corresponding multiplication result in the DCT transform calculation. The storage device 70 saved the pixels' value 78 with the corresponding result 79 of multiplication of the DCT transform. A new pixel enters the DCT calculation will be multiplied by some predetermined “DCT base function” 74 which in principle consumes a lot of computing time of multiplication and a lot of logic gate will toggle with high power consumption. Here is a state machine within the “DCT Calculation” 75 functional block, which controls the data flow of DCT, transform. When the coming pixel has no equal pixel in previous pixels, the controller takes a pixel with closest value plus addition and/or subtracts and/or shifts to represent the result of the pixel's multiplication. For example, if a new pixel value is 7, if no previously saved pixel with value of 7, a pixel with multiplication of 8 and subtract 7 can be taken to represent the multiplication of 7. This helps in reducing the long delay of multiplication since multiplication takes long propagating delay.

The present invention takes advantage of the close correlation between pixels in determining the block pixel variance range and other decision-making. According to another embodiment of the present invention, since the high chance of having the same value of MSB bits, when calculating the pixel variance range, average or sum of a block pixels, only few LSB, least Significant Bits are calculated. The MSB bits become the “base” and can be shifted up and are added to make up the total sum. This alternative allows more operands to be calculated in the same time and saves the time of computing. The result of the DCT lookup mapping and the DCT calculation fill the DCT coefficients output buffer 77.

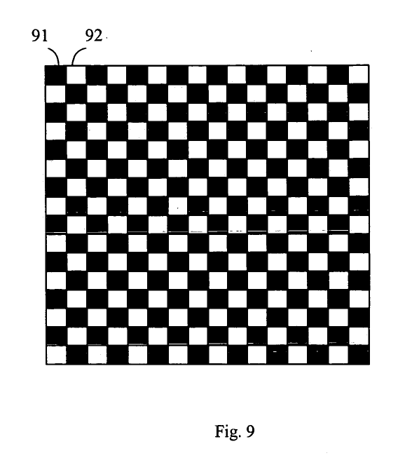

Most of the operations of the present invention as illustrated above, for performance enhancement reason, the DCT pre-processing step is coupled with the using of the sub-sampling alternative. FIG. 9 illustrates the means of the pixel sub-sampling and examples of a 2:1 sub-sampling ratio. Since sub-sampling does not include all pixels in the calculation of pixel average or variance range, some degree of potential error is expected. For minimizing the error caused by sub-sampling, the present invention uses an optimized sub-sampling means by periodically rotating the selection pixel of each frame of a video sequence in motion video applications. In selecting the sub-sampling ratio, it is decided that the higher block pixel variance of previous frame in motion video, the smaller sub-sampling rate will be. From the other hand, the smaller block pixel range, the higher sub-sampling ratio can be applied.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

1. A method for performing a fast discrete cosine transform (DCT) on an image block composed of a matrix of pixels, comprising:
calculating a block variance of an image block, said block variance indicating range of a block pixels;
determining a number of DCT coefficients to be calculated according to the block variance; and
calculating the value of DCT coefficients.

2. The method of claim 1, wherein a block variance is the range of block pixels, and determining a number of DCT coefficients nned to be calculated by comparing the block variance to at least one threshold values.

3. The method of claim 2, wherein, if the block variance is less than a first threshold value, the DCT coefficients are calculated by searching a lookup table, and the DCT coefficients are calculated by DCT transformation if the pixel range is larger than a first threshold value.

4. The method of claim 3, wherein the number of DCT coefficients need to be calculated is a limited portion of all DCT coefficients if the block variance is larger than the first threshold value and less than a second threshold value, and the number of DCT coefficients need to be calculated are all DCT coefficients if the pixel range is larger then the second threshold value.

5. The method of claim 2, wherein the pixel range of the image block indicates differences between adjacent pixels within an image block.

6. The method of claim 1, wherein only LSB bits of the pixels of an image block are calculated when determining the amount of DCT coefficients need to be calculated.

7. The method of claim 1, wherein the sub-sampling is applied for calculating variance range of block pixels to determine the amount of DCT coefficients need to be calculated.

8. The method of claim 7, wherein the sub-sampling periodically rotates selection position of a block image from a frame to another frame.

9. The method of claim 1, further providing a storage device for saving calculation result during calculating the value of DCT coefficients, and the storage device is searched for preventing unnecessary calculations when calculating the value of DCT coefficients.

10. A method for determining DCT coefficients on an image block, comprising:
comparing a variance range of block pixel differences to predetermined thresholds; and
using predetermined values to represent DCT coefficients if a variance range of block pixels is within a first threshold.

11. The method of claim 10, wherein a DC coefficient of block pixels is represented by a predetermined value by comparing the variance range of a block pixels and quantization scales.

12. The method of claim 10, wherein a limited amount of AC coefficients of block pixels are represented by predetermined values.

13. A compression circuit for calculating DCT coefficients of an image block, comprising:
a calculating device for calculating a variance range of the image block;
a decision device coupled to the calculation device for discarding a number of DCT coefficients so that they don't need to be calculated to spare times of calculation, and
a DCT calculation device for performing DCT of those coefficients that need to be calculated.

14. The compression circuit of claim 13, further comprises a lookup table for storing the range of block pixels and determining a limited amount of the corresponding DCT coefficients.

15. The apparatus of claim 13, wherein a certain amount of non-zero DCT coefficients are calculated by comparing quantization scale to block pixel variance range.

16. The apparatus of claim 13, wherein block pixels are compared to decide how many LSB bits are needed in calculation of the DCT coefficients.

17. The apparatus of claim 13, wherein the MSB bits is combined with LSBs to make up the total sum of block pixels.

18. The apparatus of claim 13, wherein the MSB bits is combined with LSBs to calculate the variance of block pixels.

19. The apparatus of claim 13, wherein an operand selection unit compares a pixel to other pixels stored in a storage device to select a result of the closest pixel for further manipulation of the DCT calculations.

20. The apparatus of claim 13, wherein an output buffer storing the DCT coefficients combines results of DCT lookup table mapping and DCT calculation to form the complete DCT coefficients.
